(19) United States
(12) Patent Application Publication
(10) Pub. No.: US 2011/0184955 A1
(43) Pub. Date: Jul. 28, 2011

(54) ORGANIZING DATA

(76) Inventors: April Sleyoen Mitchell, San Jose, CA (US); Mitchell Trott, San Meteo, CA (US); W. Alex Vorbau, Los Altos, CA (US)

(21) Appl. No.: 13/122,432

(22) PCT Filed: Oct. 31, 2008
(86) PCT No.: PCT/US08/82151

§ 371 Date: Apr. 4, 2011

(51) Int. Cl. G06F 17/30

(52) U.S. Cl. 707/740; 707/E17.009; 707/E17.046

(57) ABSTRACT

Organizing video data [110] is described. Video data [110] comprising metadata is received [205], wherein the metadata [120] provides an intra-video tag of the video data [110]. The metadata [120] is compared [210] with a plurality of video profiles [130]. Based on the comparing [210], the video data [110] is associated [215] with a corresponding one of the plurality of video profiles [130].

### FIELD

The field of the present technology relates to computing systems. More particularly, embodiments of the present technology relate to video streams.

### BACKGROUND

Participating in the world of sharing on-line videos can be a rich and rewarding experience. For example, one may easily share on-line videos with friends, family, and even strangers. Generally, the modern day computer allows a user to organize and store a large number of on-line videos. However, in order to store and share hundreds of on-line videos, the user expends much time and effort making hundreds of organizational decisions.

### BRIEF DESCRIPTION OF THE DRAWINGS

The accompanying drawings, which are incorporated in and form a part of this specification, illustrate embodiments of the technology for organizing video data, together with the description, serve to explain principles discussed below:

FIG. 1 is a block diagram of an example system of organizing video data, in accordance with embodiments of the present technology.

FIG. 2 is an illustration of an example method of organizing video data, in accordance with embodiments of the present technology.

FIG. 3 is a diagram of an example computer system used for organizing video data, in accordance with embodiments of the present technology.

FIG. 4 is a flowchart of an example method of organizing video data, in accordance with embodiments of the present technology.

The drawings referred to in this description should not be understood as being drawn to scale unless specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, embodiments of the present technology may be practiced without these specific details. In other instances, well known methods, procedures, components, and circuits have not been described in detail as not to unnecessarily obscure aspects of the present embodiment.

Unless specifically stated otherwise as apparent from the following discussions, it is appreciated that throughout the present detailed description, discussions utilizing terms such as “receiving”, “comparing”, “associating”, “identifying”, “removing”, “utilizing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### OVERVIEW OF DISCUSSION

Embodiments in accordance with the present technology pertain to a system for organizing video data and its usage. In one embodiment in accordance with the present technology, the system described herein enables the utilization of a user's deliberately created metadata within a video to organize that video within a database.

More particularly, in one embodiment metadata comprising visual and/or audio cues are included by a user in the video and then utilized to find a corresponding video profile with matching visual and/or audio cues. This video profile may be stored within a database of a plurality of video profiles. Each video profile is a combination of features extracted from the video that are suitable for making subsequent comparisons with the video, as will be described. These features may include the entire video or portions thereof, as well as a point of reference to the original video. The video is then associated with any corresponding video profile that is found. Thus, the video is organized based on metadata that was included in the video by the user.

For example, a user may first cover and uncover a video camera's lens while the video camera is recording to create a “dark time” within video “A”. This “dark time” signifies that important visual and/or audio cues will occur shortly. Then, the user may place a visual cue within video “A” by recording a short video of an object, such as a diamond, as part of video “A”. The user then may place an audio cue within video “A” by recording the spoken words, “research project on diamonds”, within video “A”. The visual cue and the audio cue then may be stored as part of a video profile associated with video “A” in a database coupled with the system described herein.

Then, when the user creates a new video to share, video “B”, the user may make a video recording of the diamond at the beginning of video “B”. Embodiments of the present technology then receive video “B” that includes the recording of the diamond. Video “B” and its visual and audio cues within are then compared to a database of a plurality of video profiles in order to find a video profile with matching visual and audio cues.

Once a video profile “C” that matches the visual and audio cues of video “B” is found, video “B” is associated with the group of one or more other videos also associated with video profile “C”. For example, the appropriate association for video “B” is with the group of one or more videos having the visual and/or audio cues, a diamond and the spoken words, “research project on diamonds”. Additionally, in one embodiment, the recording of the diamond and the spoken words, “research project on diamonds”, may be removed from video “B” before video “B” is shared with others.

Thus, embodiments of the present technology enable the organizing of a video based on the comparison of the metadata within this video with a plurality of stored video profiles. This method of organizing enables the associating of a video with videos containing matching metadata, without manual interaction by a user.

### System for Organizing Video Data

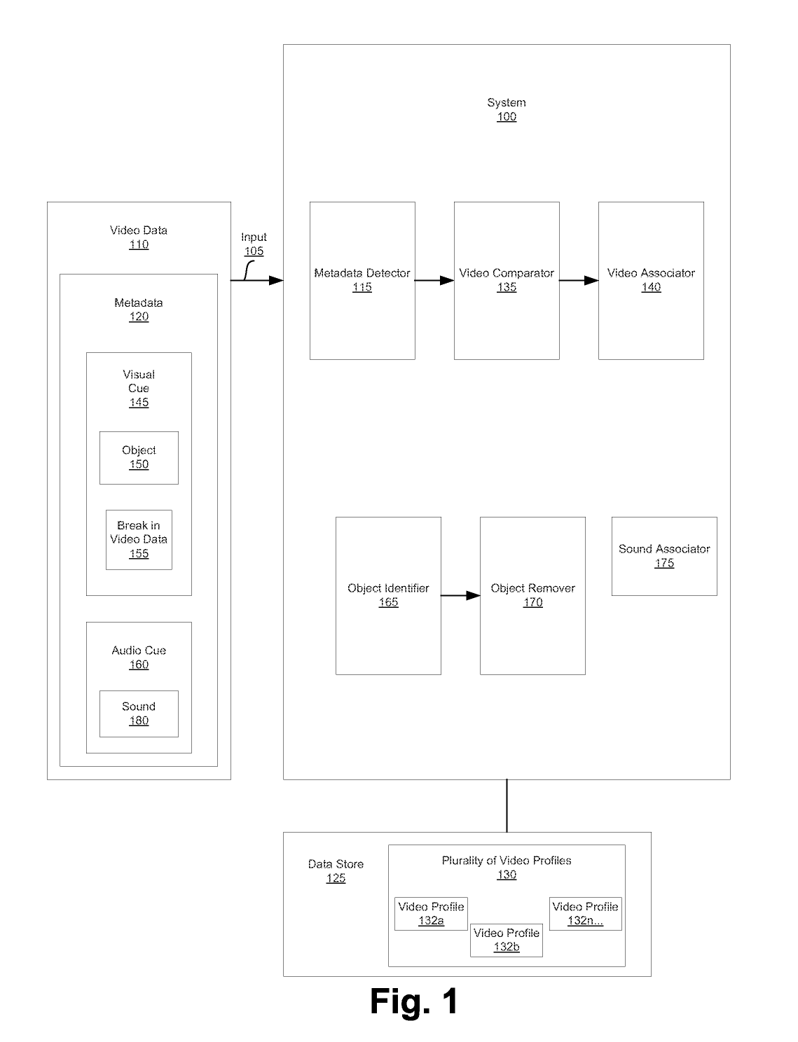

FIG. 1 is a block diagram of an example system 100 in accordance with embodiments of the present technology. System 100 includes input 105, metadata detector 115, video comparator 135, video associator 140, object identifier 165, object remover 170, and sound associator 175.

Referring still to FIG. 1, in one embodiment, system 100 receives video data 110 via input 105. Video data 110 is an audio/video stream and may be an entire video or a portion less than a whole of a video. For purposes of brevity and clarity, discussion and examples herein will most generally refer to video data 110. However, it is understood that video data 110 may comprise an entire video or portions thereof.

Video data 110 comprises metadata 120 used to organize video data 110. Metadata 120 is included as part of the audio/video stream. Metadata 120 may comprise a visual cue 145 and/or an audio cue 160. Video data 110 may have an intra-video tag of one or more visual cues 145 and/or audio cues 160.

Visual cue 145 refers to anything that may be viewed that triggers action and/or inaction by system 100. Audio cue 160 refers to any sound that triggers action and/or inaction by system 100. An “intra-video tag” refers to the inclusion, via recording, of metadata 120, such as visual cue 145 and audio cue 160, as part of video data 110. In other words, video data 110 comprises a video or portions thereof that includes metadata 120 as part of its audio/video stream. This metadata assists system 100 in organizing video data 110 into related groups.

In one embodiment, visual cue 145 comprises an object 150 and/or a break in video 155. For example, video data 110 may have an intra-video tag of object 150, such as but not limited to, a piece of jewelry, a purple pen, a shoe, headphones, etc.

Break in video 155 refers to a section of video data 110 that is different from its preceding section or its following section. For example, break in video 155 may be a result of a user covering a camera's lens while in the recording process, thus creating a “dark time”. In another example, break in video 155 may also be a period of “lightness” in which video data 110 is all white. In yet another example, break in video 155 may be a particular sound, such as an audible clap or an audible keyword, which is predetermined to represent the beginning or the ending of a section of video data 110.

In one embodiment, audio cue 160 comprises sound 180. Sound 180 for example, may be but is not limited to, a horn honking, a buzzer buzzing, or a piano key sounding.

Coupled with system 100 is plurality of video profiles 130. In one embodiment, plurality of video profiles 130 is coupled with data store 125. Plurality of video profiles 130 comprises one or more video profiles, for example, video profiles 132a, 132b, and 132n . . . .

### Operation

More generally, in embodiments in accordance with the present technology, system 100 utilizes metadata 120, such as one or more visual cues 145 and/or audio cues 160 to automatically organize video data 110 by associating video data 110 with a corresponding one of a plurality of video profiles 130. Such a method of organizing video data 110 is particularly useful to match video data 110 with similar video data, without a user having to manually organize the video data 110, thus saving time and resources.

For example, video data 110 may have an intra-video tag of metadata 120. For example, in one embodiment, video data 110 may have an intra-video tag of visual cue 145 such as an object 150, a diamond. In another embodiment, video data 110 may have an intra-video tag of audio cue 160, such as a spoken description of a particular author, “Tom Twain”. In another example, video data 110 may have an intra-video tag of more than one object 150, such as a purple pen and a notebook, disposed next to each other.

In one embodiment, a user may cover the lens of a camera and begin video recording, thus generating “dark time” in video data 110, represented by video data “D”. The content of video data “D” resembles a re-enactment of Beethoven's 3^{rd} symphony. This “dark time” is considered to be a break in video “D”. During this “dark time”, the user may include an audio cue 160 within video data “D” by playing sound 180 of a piano note, that of “middle C”. The user may then uncover the lens of the camera while finishing the recording. Metadata 120, including this break in video 155, its associated “dark time”, and the sound of “middle C”, is stored along with plurality of video profiles 130 within data store 125.

Referring still to FIG. 1 and continuing with the example of video data “D”, input 105 receives video data “D”. Metadata detector 115 detects metadata 120 within video data “D”. For example, metadata detector 115 detects break in video 155 and its associated “dark time”, and the sound of “middle C”. Of note, each of breaks in video 155 and its associated “dark time”, and the sound of “middle C”, alone or in combination, provide an intra-video tag of video data “D”.

Video comparator 135 compares metadata 120 with a plurality of video profiles 130. Plurality of video profiles 130 are stored in data store 125, wherein data store 125 is coupled with system 100, either internally or externally. For example, video comparator 135 compares break in video 155 and its associated “dark time”, and the sound of “middle C”, with plurality of video profiles 130 in order to find a video profile with a matching break in video 155 and its associated “dark time”, and the sound of “middle C”.

Then, video associator 140 associates video data “D” with a corresponding one of the plurality of video profiles 130 based on the comparing. For example, if after comparing, system 100 finds a video profile 132b that matches video data “D”, then video data “D” is associated with video profile 132h. By being associated, video data “D” is placed alongside other videos having similar video profiles. In other words, in one embodiment video data “D” is listed along with a group of one or more other videos that match the video profile of video data “D”.

For example, based on its video profile, video data “D” may be listed with a group of videos, wherein the content of the group of videos includes the following: a child's piano rendition of “Twinkle, Twinkle, Little Star”, a trumpeted salute to a school flag performed by a school band, a German lullaby sung by an aspiring actress, and a lip-synced version of the user's favorite commercial ditty. Of note, each of the group of videos contains the metadata of a break in video and its associated “dark time” and the sound of “middle C”.

In one embodiment, a match is found if the match surpasses a threshold level of similarities and/or differences. A threshold level of similarities and/or differences may be based on any number of variables, such as but not limited to: color, lighting, decibel level, range of tones, movement detection, and association via sound with a particular topic (e.g., colors, numbers, age), For example, even if the spoken words, “purple pen”, are different from the spoken words, “blue pen”, of a video profile, system 100 tray still find “purple pen” to match video profile containing the audio cue of “blue pen”. For instance, a threshold level may be predetermined to be such that any sound matching a description of a color is to be included within a listing of a group of videos associated with the video profile containing the audio cue of “blue pen”.

In another embodiment, system 100 associates video data 110 with the corresponding one of plurality of video profiles 130 that most closely matches metadata 120 within video data 110. For example, metadata 120 within video data 110 (represented by video data “E”) may be that of a parrot as object 150. In this example, there exist three video profiles within plurality of video profiles 130, that of 132a, 132b, and 132c. Video profile 132a of plurality of video profiles 130 includes a frog as object 150. Video profile 132b of plurality of video profiles 130 includes a snake as object 150. Video profile 132c of plurality of video profiles 130 includes a chicken as object 150. System 100 associates video data “E” with video profile 132e since a chicken of video profile 132c is closest to the metadata of video data “E”, a parrot. Both a chicken and a parrot have feathers and a more similar body type than that of a parrot versus a frog or a parrot versus a snake.

As described herein, visual cue 145 may be an object, such as a rhinestone. Furthermore, after the rhinestone is used as visual cue 145 once, new videos may be created using the rhinestone as an intra-video tag. For example, the user may create a new video with a recorded visual image of the rhinestone, which gets organized with other videos containing the same intra-video tag of a rhinestone.

In one embodiment, a group of videos on the same topic, making a cake, are considered to be related and are all have the intra-video tag of an image of a famous chef covered in flour making his favorite buttery concoction. In another example, a user may provide an intra-video tag of the audio cue, “nine years old”, for each of a group of videos that contain the seemingly unrelated topics of Fred Jones playing a soccer game, Susie Smith entering fourth grade, and Jeff Johnson feeding his new puppy.

In one embodiment, a new video being created, video data “F”, has an intra-tag of more than one metadata 120. For example, video data “F” may have the intra-video tag of a skateboard (visual cue 145) and the spoken words, “nine years old” (audio cue 160).

In another embodiment, sound associator 175 associates sound 180 with object 150. In one example, a user records on a first video a purple pen as object 150 as well as the spoken words, “tax preparation”, as sound 180. Sound associator 175 associates sound 180, “tax preparation”, with object 150, the purple pen. In other words, a video profile is created that links the purple pen with the spoken words, “tax preparation”.

Furthermore, each of a group of video conversations related to tax preparation may have an intra-video tag of a “purple pen”. A user wishing to include a new video, video “G” whose content relates to “conversations of 2008 tax preparation”, within the current group of videos having the intra-video tag of a “purple pen” may simply record within video “G” a visual image of a “purple pen”.

In another embodiment, a user creates a new video having the spoken words, “research project on jewelry”, as its audio cue 160. For example, the user may create a “dark time” in the new video and speak the words, “research project on jewelry”. The video profile of this new video then includes the “dark time” and the spoken words, “research project on jewelry”. In one embodiment, more metadata 120 may be added to this video profile. For example, a visual cue of a diamond may be recorded in the video and linked with the audio cue of the spoken words, “research project on jewelry”.

In one embodiment, object identifier 165 identifies a portion of video data 110 that comprises metadata 120, such as visual cue 145 and/or audio cue 160. Object remover 170 then is able to remove this metadata 120 from video data 110. For example, object identifier 165 identifies the portion of video data 110 that comprises the spoken word, “diamond”. Object remover 170 may then remove the spoken word, “diamond” from video data 110. Of note, embodiments of the present technology are well suited to enabling removal of metadata 120 at any time, according to preprogrammed instructions or instructions from a user. For example, metadata 120 may be removed before or after video data 110 is shared with others.

In yet another embodiment, system 100 matches more than one object 150, such as a pencil and a notebook with a video profile containing both of these objects.

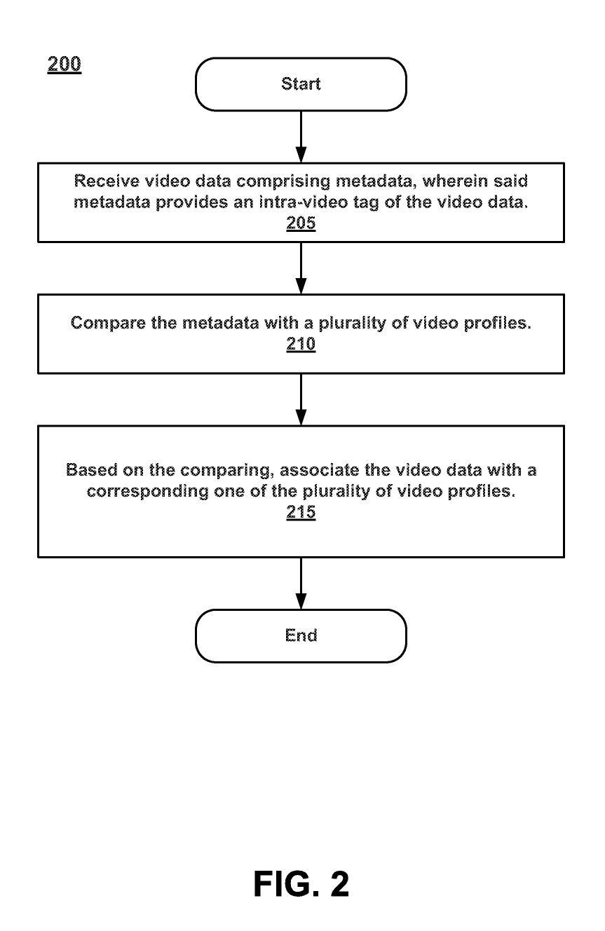

FIG. 2 is a flowchart of an example method of organizing video data, in accordance with embodiments of the present technology. With reference now to 205, video data 110 comprising metadata 120 is received, wherein metadata 120 provides an intra-video tag of video data 110.

Referring to 210 of FIG. 2, in one embodiment of the present technology, metadata 120 is compared with plurality of video profiles 130. Referring to 215 of FIG. 2, based on the comparing, video data 110 is associated with a corresponding one of the plurality of video profiles 130.

Thus, embodiments of the present technology provide a method for organizing video data without any manual interaction by a user. Additionally, embodiments provide a method for automatic organizing of video data based on video and/or audio cues. Furthermore, embodiments of the present technology enable a user to automatically associate video data with videos containing matching video data, thus requiring no manual interactions when the user uploads the video data for sharing. Additionally, portions of the video data enabling this organizing may be identified and removed before the video data is uploaded.

### Example Computer System Environment

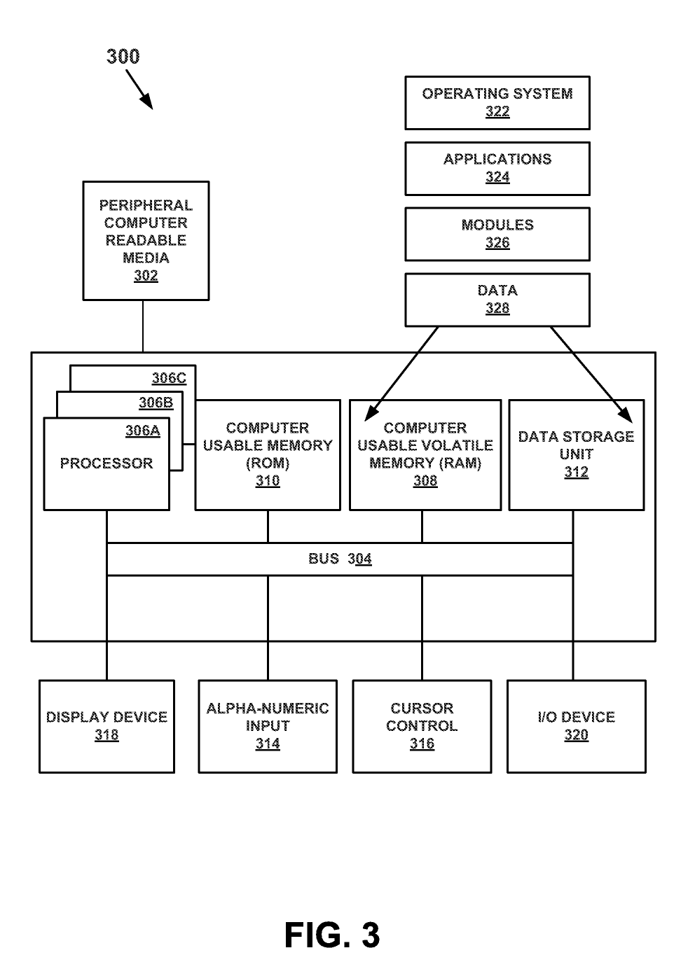

With reference now to FIG. 3, portions of embodiments of the present technology for organizing video data are composed of computer-readable and computer-executable instructions that reside, for example, in computer-usable media of a computer system. That is, FIG. 3 illustrates one example of a type of computer that can be used to implement embodiments, which are discussed below, of the present technology.

FIG. 3 illustrates an example computer system 300 used in accordance with embodiments of the present technology. It is appreciated that system 300 of FIG. 3 is an example only and that embodiments of the present technology can operate on or within a number of different computer systems including general purpose networked computer systems, embedded computer systems, routers, switches, server devices, user devices, various intermediate devices/artifacts, stand alone computer systems, and the like. As shown in FIG. 3, computer system 300 of FIG. 3 is well adapted to having peripheral computer readable media 302 such as, for example, a compact disc, and the like coupled thereto.

System 300 of FIG. 3 includes an address/data bus 304 for communicating information, and a processor 306A coupled to bus 304 for processing information and instructions. As depicted in FIG. 3, system 300 is also well suited to a multi-processor environment in which a plurality of processors 306A, 30613, and 306C are present. Conversely, system 300 is also well suited to having a single processor such as, for example, processor 306A. Processors 306A, 306B, and 306C may be any of various types of microprocessors. System 300 also includes data storage features such as a computer usable volatile memory 308, e.g. random access memory (RAM), coupled to bus 304 for storing information and instructions for processors 306A, 306B, and 306C.

System 300 also includes computer usable non-volatile memory 310 e.g. read only memory (ROM), coupled to bus 304 for storing static information and instructions for processors 306A, 306B, and 306C. Also present in system 300 is a data storage unit 312 (e.g., a magnetic or optical disk and disk drive) coupled to bus 304 for storing information and instructions. System 300 also includes an optional alpha-numeric input device 314 including alphanumeric and function keys coupled to bus 304 for communicating information and command selections to processor 306A or processors 306A, 306B, and 306C. System 300 also includes an optional cursor control device 316 coupled to bus 304 for communicating user input information and command selections to processor 306A or processors 306A, 306B, and 306C. System 300 of embodiments of the present technology also includes an optional display device 318 coupled to bus 304 for displaying information.

Referring still to FIG. 3, optional display device 318 of FIG. 3 may be a liquid crystal device, cathode ray tube, plasma display device or other display device suitable for creating graphic images and alpha-numeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick or special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. System 300 also includes an I/O device 320 for coupling system 300 with external entities.

Referring still to FIG. 3, various other components are depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312.

Computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

Embodiments of the present technology may be described in the general context of computer-executable instructions, such as program modules, being executed by a computer. Generally, program modules include routines, programs, objects, components, data structures, etc., that perform particular tasks or implement particular abstract data types. Embodiments of the present technology may also be practiced in distributed computing environments where tasks are performed by remote processing devices that are linked through a communications network. In a distributed computing environment, program modules may be located in both local and remote computer-storage media including memory-storage devices.

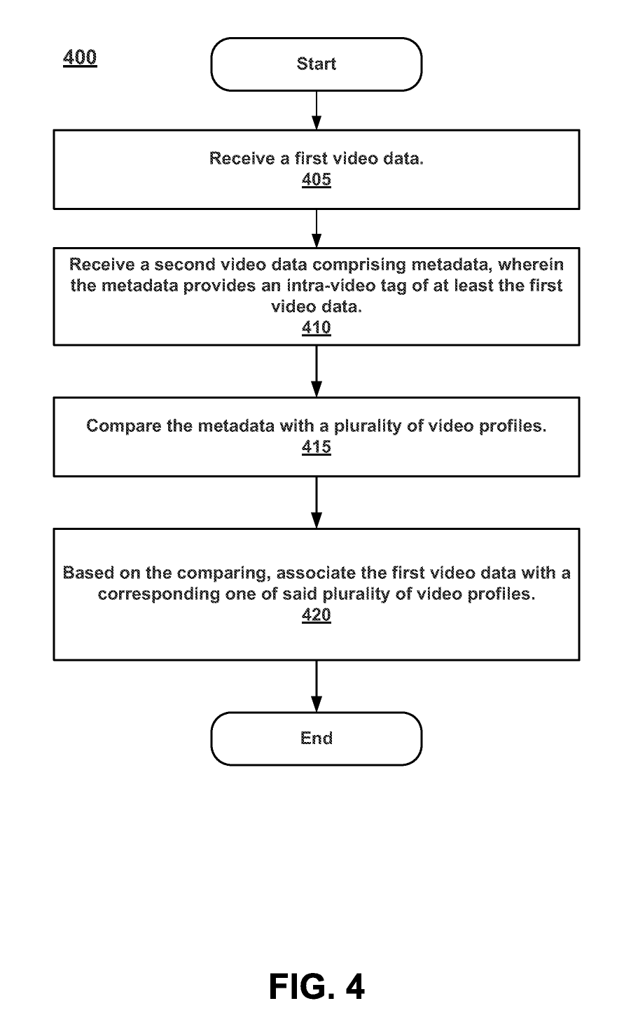

FIG. 4 is a flowchart illustrating a process 400 for organizing video data, in accordance with one embodiment of the present technology. In one embodiment, process 400 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. In one embodiment, process 300 is performed by system 100 of FIG. 1.

Referring to 405 of FIG. 4, in one embodiment, a first video data is received. Referring to 410 of FIG. 4, in one embodiment, a second video data comprising metadata 120 is received, wherein metadata 120 provides an intra-video tag of the first video data. Referring now to 415 of FIG. 4, metadata 120 is compared with plurality of video profiles 130. Referring to 420 of FIG. 4, based on the comparing, the first video data is associated with a corresponding one of the plurality of video profiles.

For example, a user creates two videos. The first video data “H” contains a video of the user's wedding dress. The second video “I” contains a recording of a wedding ring. The user then is able to upload the first video data “H” and the second video data “I” and organize first video data “H” based on second video data “I”'s metadata of a wedding ring.

For example, the first video data “H” is received. A second video data “I” is also received, wherein second video data “I” comprises metadata 120 that provides an intra-video tag described herein of the first video data “H”. In essence, second video data “I” is representing first video data “H”'s metadata for organizational purposes. In one embodiment, the first video data “H” comprises the second video data “I”.

Additionally, in another embodiment the user decides to create a third video, video data “J”, of the flower arrangement for the wedding. According to embodiments of the present technology, user is able to upload the third video data “J” and organize third video data “J” based on second video data “I”'s metadata of a wedding ring.

In another embodiment, visual cue 145 is utilized as metadata 120 to organize first video data “H” in yet another embodiment, audio cue 160 is utilized as metadata 120 to organize first video data “H”.

Thus, embodiments of the present technology enable the organizing of video data without manual interaction. Such a method of organizing is particularly useful for sorting large numbers of videos in a short period of time.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system [100] for organizing video data, said system [100] comprising:
an input [105] for receiving video data [110];
a metadata detector [115] configured for detecting metadata [120] within said video data [110], wherein said metadata [120] provides an intra-video tag of said video data [110];
a data store [125] for storing a plurality of video profiles [130];
a video comparator [135] configured for comparing said metadata [120] with said plurality of video profiles [130]; and
a video associator [140] configured for associating said video data [110] with a corresponding one of said plurality of video profiles [130] based on said comparing.

2. The system [100] of claim 1, wherein said metadata detector [115] is configured for detecting metadata [120] in said video data [110] indicating a visual cue [145].

3. The system [100] of claim 2, wherein said metadata detector [115] is configured for detecting metadata [120] in said video data [110] indicating an object [150].

4. The system [100] of claim 2, wherein said metadata detector [115] is configured for detecting metadata [120] in said video data [110] indicating a break in said video data [155].

5. The system [100] of claim 1, wherein said metadata detector [115] is configured for detecting metadata [120] in said video data [110] indicating an audio cue [160].

6. The system [100] of claim 1, further comprising:
an object identifier [165] configured for identifying a portion of said video data that comprises said metadata [120]; and
an object remover [170] configured for removing said metadata. [120] from said video data [110].

7. The system [100] of claim 3, further comprising:
a sound associator [175] configured for associating a sound [180] with said object [150].

8. A computer implemented method [200] of organizing video data, said method comprising:
receiving [205] video data [110] comprising metadata [120], wherein said metadata [120] provides an intra-video tag of said video data [110];
comparing [210] said metadata [120] with a plurality of video profiles [130],
based on said comparing, associating [5] said video data [110] with a corresponding one of said plurality of video profiles [130].

9. The method [200] of claim 8, wherein said removing further comprising:
identifying a portion of said video data [110] that comprises said metadata [120]; and
removing said metadata [120] from said video data [110].

10. The method [200] of claim 8, further comprising:
utilizing a visual cue [145] as said metadata [120] to organize said video data [110].

11. The method [200] of claim 8, further comprising:
utilizing an audio cue [145] as said metadata [120] to organize said video data [110].

12. A computer usable medium comprising instructions that when executed cause a computer system to perform a method [400] of organizing video data [110], said method comprising:
receiving [405] a first video data;
receiving [410] a second video data comprising metadata [120], wherein said metadata [120] provides an intra-video tag of at least said first video data;
comparing said metadata [120] with plurality of video profiles [130]; and
based on said comparing, associating [420] said first video data with a corresponding one of said plurality of video profiles [130].

13. The method [400] of claim 12, wherein said first video data comprises said second video data.

14. The method [400] of claim 12, further comprising:
utilizing a visual cue [145] as said metadata [120] to organize said first video data.

15. The method [400] of claim 12, further comprising:
utilizing an audio cue [160] as said metadata [120] to organize said first video data.
